(19) United States
(12) Patent Application Publication
(10) Pub. No.: US 2015/0215602 A1
(43) Pub. Date: Jul. 30, 2015

(54) METHOD FOR AJDUSTING STEREO IMAGE AND IMAGE PROCESSING DEVICE USING THE SAME

(71) Applicant: HTC Corporation, Taoyuan County (TW)

(72) Inventors: Ruey-Jer Chang, Taoyuan County (TW); Lun-Cheng Chu, Taoyuan County (TW); Zih-Ci Lin, Taoyuan County (TW); Wei-Chung Yang, Taoyuan County (TW)

(73) Assignee: HTC Corporation, Taoyuan County (TW)

(21) Appl. No.: 14/166,858

(22) Filed: Jan. 29, 2014

(51) Int. Cl. H04N 13/00; H04N 13/04

(52) U.S. Cl. CPC H04N 13/0033; H04N 13/0022; H04N 13/0425; H04N 2013/0081

(57) ABSTRACT

A method for adjusting a stereo image and an image processing device using the same are provided. The stereo image is displayed on a screen. The method includes following steps. A plurality of depth values of the stereo image are obtained, where a plurality of first depth values correspond to a boundary region of the screen. It is determined whether one of the first depth values is negative parallax. If one of the first depth values is negative parallax, the depth values are adjusted such that the first depth values are not negative parallax. In this way, stereoscopic window violation is avoided.

### BACKGROUND

1. Technical Field

The invention relates to an adjusting method. Particularly, the invention relates to a method for adjusting a stereo image and an image processing device using the same.

2. Related Art

A stereo image is composed of more than two images of different viewing angles. When a user views a stereo image display, a left eye of the user views an image of one viewing angle, and a right eye views an image of another viewing angle, such that a 3-dimension image is produced in user's brain. However, the images of different viewing angles are displayed on a screen in a plane, so that the user's eyes focus on the screen, and the user's brain produces the stereo image located in front of or behind the screen. Such situation may lead to a dizzy or uncomfortable feeling of the user. When an object in the stereo image is displayed at a screen boundary, a part of the object is probably “shielded” by the screen boundary. When the user's eyes view the part of the object shielded by the screen boundary, the user may intuitively regard that the shielded part is imaged behind the screen. However, if the part of the object that is not shielded by the screen is imaged in front of the screen, the user may have an uncomfortable feeling, and such situation is referred to as stereoscopic window violation.

Referring to FIG. 1, if the left eye 110 view an image 120, and the right eye views an image 122, the user may feel that an object 130 is imaged in front of a screen 140. However, an object 150 is shielded by the screen 140, and the user is hard to produce the shielded object 150 in the brain, so that the user may have an uncomfortable feeling.

Therefore, how to avoid the stereoscopic window violation is an important issue concerned by related technicians.

### SUMMARY

Accordingly, the invention is directed to a method for adjusting a stereo image and an image processing device using the same, by which stereoscopic window violation is avoided.

An embodiment of the invention provides a method for adjusting a stereo image, which is adapted to an image processing device. The stereo image is displayed on a screen. The method includes following steps. A plurality of depth values of the stereo image are obtained, where a plurality of first depth values correspond to a boundary region of the screen. It is determined whether one of the first depth values is negative parallax. If one of the first depth values is negative parallax, the depth values are adjusted such that the first depth values are not negative parallax.

In an embodiment, the stereo image includes a first image and a second image. The steps of obtaining the depth values of the stereo image includes following steps. A plurality of first feature points of the first image are obtained, and a plurality of second feature points of the second image are obtained, and the first feature points and the second feature points are matched to calculate the depth values.

In an embodiment, the step of determining whether one of the first depth values is the negative parallax includes following steps. A minimum depth value in the first depth values is obtained, and it is determined whether the minimum depth value is negative parallax.

In an embodiment of the invention, the step of adjusting the depth values such that the first depth values are not negative parallax includes following steps. The minimum depth value is added by a shift value to generate a second depth value, where the second depth value is not negative parallax, and the depth values other than the minimum depth value are added by the shift value.

In an embodiment of the invention, the second depth value is zero parallax.

According to another aspect, an embodiment of the invention provides an image processing device including a memory and a processor. The memory stores a plurality of instructions. The processor executes the instructions to execute following steps. A plurality of depth values of a stereo image are obtained, where a plurality of first depth values correspond to a boundary region of a screen. It is determined whether one of the first depth values is negative parallax. If one of the first depth values is negative parallax, the depth values are adjusted such that the first depth values are not negative parallax.

According to the above descriptions, in the method and the image processing device of the invention, the depth values can be adjusted to avoid stereoscopic window violation.

In order to make the aforementioned and other features and advantages of the invention comprehensible, several exemplary embodiments accompanied with figures are described in detail below.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic diagram of stereoscopic window violation.

FIG. 2 is a partial block diagram of an image processing device according to an embodiment of the invention.

FIG. 3 is a schematic diagram of obtaining a depth map according to an exemplary embodiment of the invention.

FIG. 4A and FIG. 4B are schematic diagrams of adjusting a depth map according to an embodiment of the invention.

FIG. 5 is a schematic diagram of displaying a stereo image according to an embodiment of the invention.

FIG. 6 is a flowchart illustrating a method for adjusting a stereo image according to an embodiment of the invention.

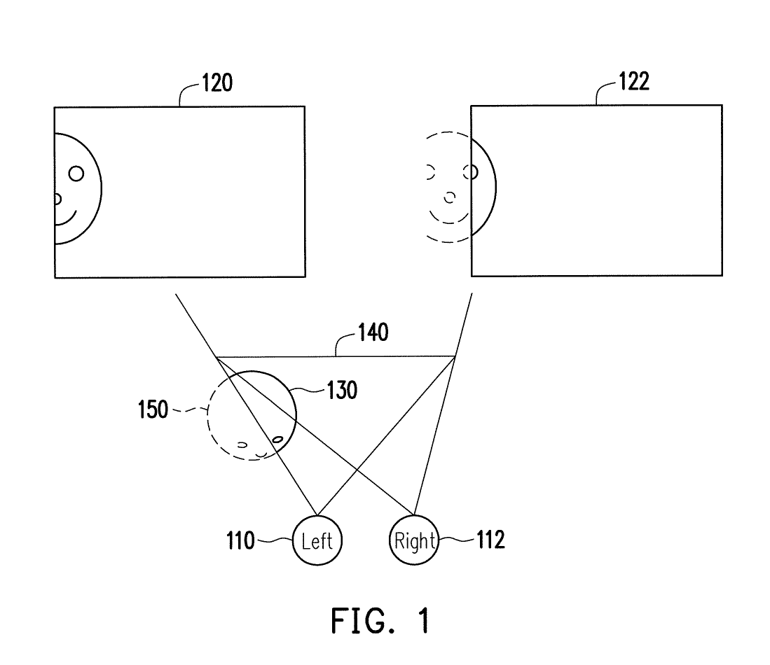

### DETAILED DESCRIPTION OF DISCLOSED EMBODIMENTS

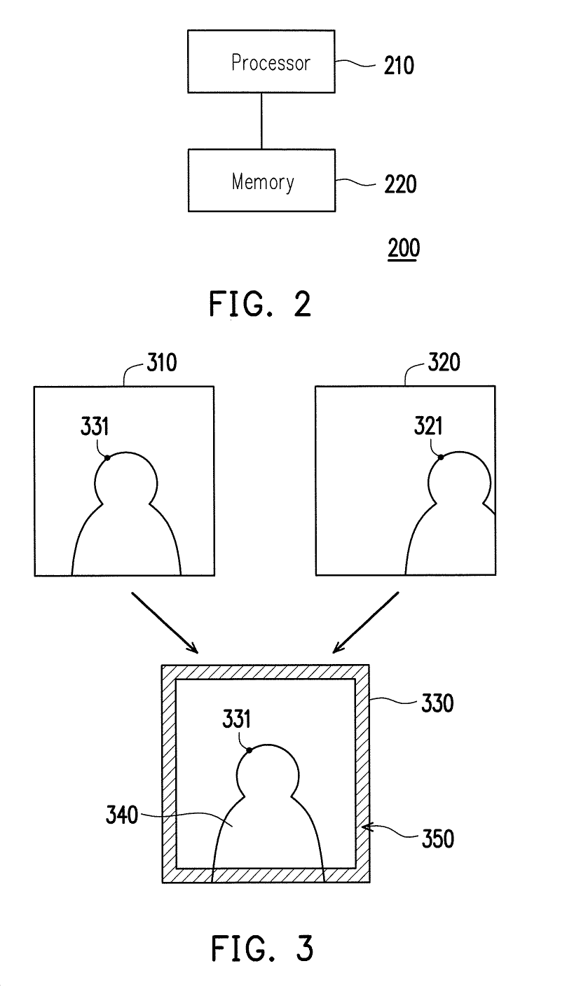

FIG. 2 is a partial block diagram of an image processing device according to an embodiment of the invention.

Referring to FIG. 2, the image processing device 200 includes a processor 210 and a memory 220. The image processing device 200 can be implemented as a computer, a server, a distributed system, a television, a smart phone, a tablet computer, an embedded system of any type or an electronic apparatus, which is not limited by the invention. In an exemplary embodiment, the image processing device 200 may further include a screen, a wired or wireless communication interface, or a power supplier, which is not limited by the invention.

The processor 210 is used for executing a plurality of instructions. For example, the processor 210 is a central processing unit (CPU), a microprocessor or a digital signal processor (DSP).

The memory 200 stores a plurality of instructions, and the processor 210 executes the instructions. For example, the memory 220 is a dynamic random access memory (DRAM), a static random access memory (SRAM), a flash memory or other memories.

FIG. 3 is a schematic diagram of obtaining a depth map according to an exemplary embodiment of the invention.

Referring to FIG. 3, the processor 210 obtains a stereo image and obtains a plurality of depth values of the stereo image. For example, the stereo image includes an image 310 and an image 320. The processor 210 obtains a plurality of feature points in the image 310 and a plurality of feature points in the image 320, and matches the feature points of the image 310 and the image 320 to generate a plurality of depth values. The depth values construct the depth map 330. For example, the processor 210 calculates a disparity between a feature point 311 and a feature point 321, so as to calculate a depth value of a position 331. The processor 210 can calculate the depth values on the depth map 330 according to any stereo matching algorithm, and the type of the stereo matching algorithm is not limited by the invention. In another exemplary embodiment, the depth map 330 can be calculated by other electronic components or electronic devices, and the calculated depth map 330 is transmitted to the processor 210. For example, the processor 210 obtains the depth map 330 and one of the image 310 and the image 320, and displays a stereo image by using a depth-image-based rendering (DIBR) algorithm, though the invention is not limited thereto.

Based on a magnitude of the depth value, an object is imaged in front of or behind the screen. If the object is imaged in front of the screen, the depth value corresponding to the object is negative parallax. Comparatively, if the object is imaged behind the screen, the depth value corresponding to the object is positive parallax. In the exemplary embodiment, a negative depth value is the negative parallax, and a positive depth value is the positive parallax. However, in other exemplary embodiments, the processor 210 can also take the positive depth value as the negative parallax, which is not limited by the invention.

Depth values (which are also referred to as first depth values) of a region 350 correspond to a boundary region of the screen. The processor 210 determines whether a depth value of negative parallax exists in the region 350, and if the depth value of negative parallax exists in the region 350, the processor 210 adjusts all of the depth values in the depth map 330, such that the depth value of negative parallax does not exist in the region 350. In the present embodiment, a width of the region 350 is one pixel. However, the width of the region 350 can also be more pixels, which is not limited by the invention. It is assumed that the depth value of an object is negative parallax, i.e. a viewer regards that the object 340 is imaged in front of a screen.

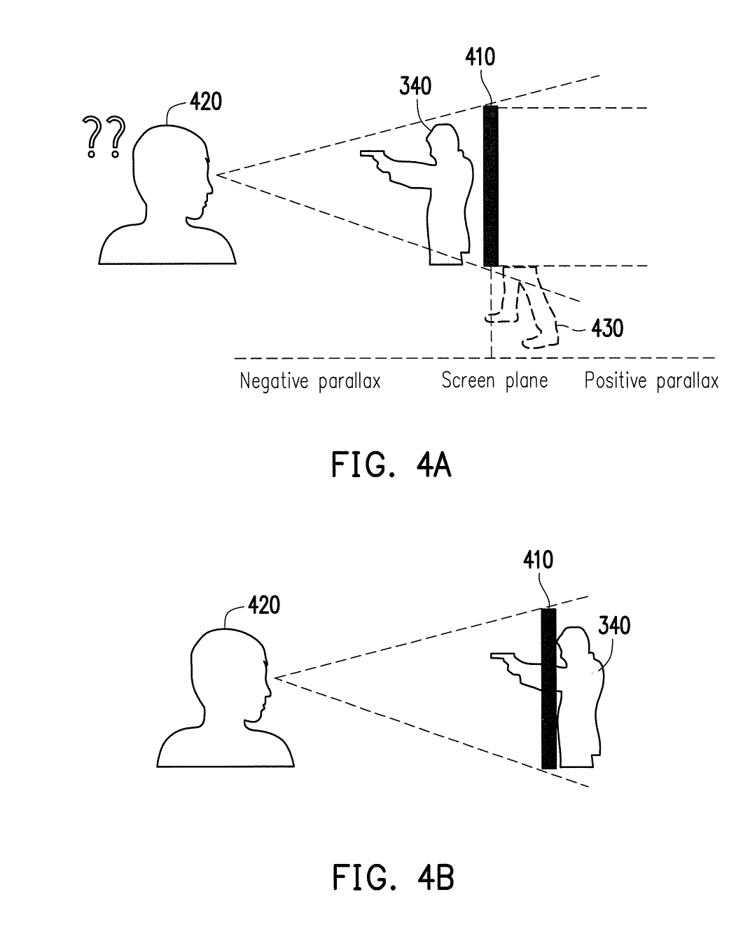

FIG. 4A and FIG. 4B are schematic diagrams of adjusting a depth map according to an embodiment of the invention.

Referring to FIG. 4A, a viewer 420 regards that an object 340 is imaged in front of a screen 410, and regards that an object 430 is imaged behind the screen 410. It should be noticed that the screen 410 does not display the content of the object 430, though the viewer 420 regards that the object 430 exists when viewing the stereo image. For example, when a last stereo image is displayed, the viewer 420 views that the object 340 and the object 430 are all behind the screen 410, and when a next stereo image is displayed, the object 340 “jumps out” of the screen 410, though the object 430 is shielded. Therefore, the viewer may have an uncomfortable feeling. In the present embodiment, the processor 210 adjusts all of the depth values, such that the depth values corresponding to a boundary region of the screen 410 are not negative parallax (shown in FIG. 4B). After the depth values are adjusted, although a part of the object 340 is still in front of the screen 410, the viewer 420 will not have the uncomfortable feeling.

Referring back to FIG. 3, for example, the processor 210 obtains a minimum depth value from the depth values of the region 350, and determines whether the minimum depth value is negative parallax (for example, determines whether the minimum depth value is smaller than 0). It is assumed that the minimum depth value is −50. The processor 210 adds the minimum depth value by a shift value to produce another depth value (which is also referred to as a second depth value), such that the second value is not negative parallax. For example, the shift value is 50, i.e. the second depth value is 0. Namely, the second depth value is zero parallax, and the object corresponding to the second depth value is imaged on the screen. Moreover, the processor 210 adds all of the depth values other than the minimum depth value by the shift value, such that all of objects in the stereo image are moved backwards. In this way, the object 340 in the region 350 is not imaged in front of the screen.

In the present embodiment, the processor 210 adds all of the depth values by the same shift value. However, in another embodiment, the processor 210 can also adds different depth values by different shift values according to the content, brightness or color of the stereo image. On the other hand, in the aforementioned example, a sum of the minimum depth value and the shift value is 0. However, in other embodiments, the sum of the minimum depth value and the shift value can be any positive number (i.e. the positive parallax), though the invention is not limited thereto.

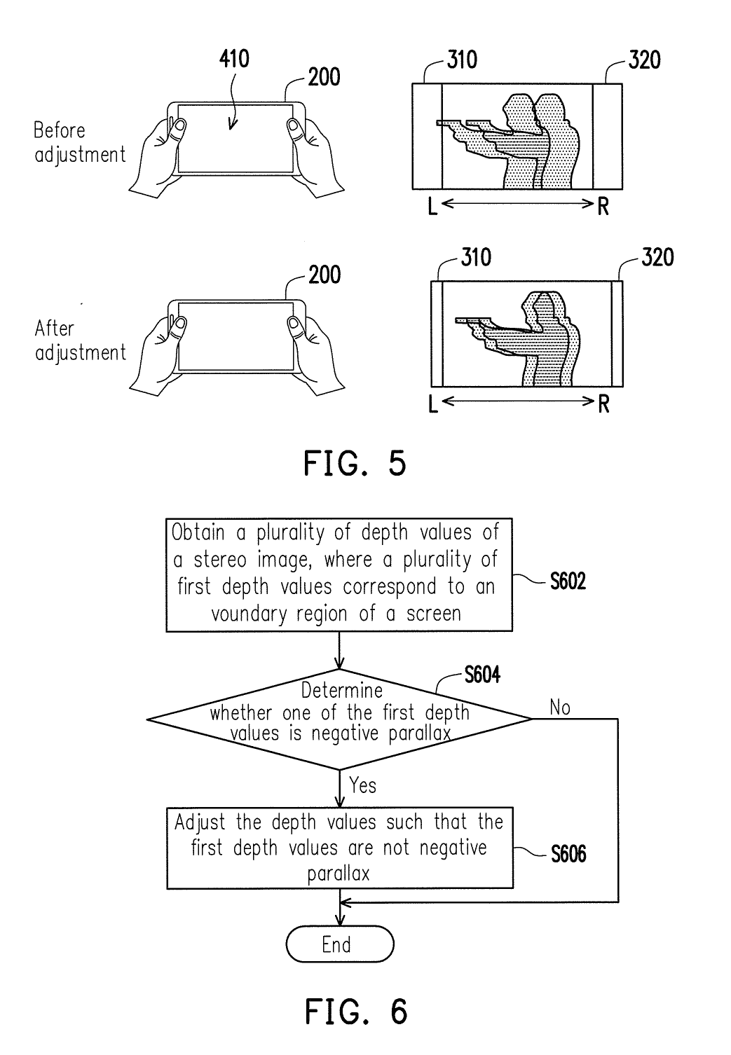

FIG. 5 is a schematic diagram of displaying a stereo image according to an embodiment of the invention.

Referring to FIG. 5, an upper half of FIG. 5 illustrates a stereo image before the depth values thereof are adjusted, and a lower half of FIG. 5 illustrates a stereo image after the depth values thereof are adjusted. The processor 210 suitably changes positions of the image 310 and the image 320 on the screen 410 according to the adjusted depth values. According to FIG. 5, it is known that after the depth values are adjusted, disparity between the image 310 and the image 320 is decreased, such that the stereoscopic window violation is avoided.

FIG. 6 is a flowchart illustrating a method for adjusting a stereo image according to an embodiment of the invention.

Referring to FIG. 6, in step S602, a plurality of depth values of the stereo image are obtained, where a plurality of first depth values correspond to an boundary region of the screen.

In step S604, it is determined whether one of the first depth values is negative parallax. If a determination result of the step S604 is negative, the flow is ended, and if the determination result of the step S604 is affirmative, a step S606 is executed.

In the step S606, the depth values are adjusted such that the first depth values are not negative parallax.

Various steps of FIG. 6 can be implemented as one or a plurality of modules, and a processor is used to execute the modules. Moreover, the steps of FIG. 6 can also be implemented as one or a plurality of circuits. Software or hardware implementation of the method for adjusting the stereo image is not limited by the invention. On the other hand, the steps of FIG. 6 have been described in detail above, which are not repeated.

In summary, in the method and the image processing device of the invention, the depth values can be adjusted when the depth values corresponding to the boundary region are negative parallax, so as to avoid the stereoscopic window violation.

It will be apparent to those skilled in the art that various modifications and variations can be made to the structure of the invention without departing from the scope or spirit of the invention. In view of the foregoing, it is intended that the invention cover modifications and variations of this invention provided they fall within the scope of the following claims and their equivalents.

What is claimed is:

1. A method for adjusting a stereo image, adapted to an image processing device, wherein the stereo image is configured to be displayed on a screen, the method for adjusting the stereo image comprising:
obtaining a plurality of depth values of the stereo image, wherein a plurality of first depth values in the depth values correspond to a boundary region of the screen;
determining whether one of the first depth values is negative parallax; and
adjusting the depth values such that the first depth values are not negative parallax.

2. The method for adjusting the stereo image as claimed in claim 1, wherein the stereo image comprises a first image and a second image, and the steps of obtaining the depth values of the stereo image comprises:
obtaining a plurality of first feature points of the first image, and obtaining a plurality of second feature points of the second image; and
matching the first feature points and the second feature points to calculate the depth values.

3. The method for adjusting the stereo image as claimed in claim 1, wherein the step of determining whether one of the first depth values is the negative parallax comprises:
obtaining a minimum depth value in the first depth values; and
determining whether the minimum depth value is negative parallax.

4. The method for adjusting the stereo image as claimed in claim 3, wherein the step of adjusting the depth values such that the first depth values are not negative parallax comprises:
adding the minimum depth value by a shift value to generate a second depth value, wherein the second depth value is not negative parallax; and
adding the depth values other than the minimum depth value by the shift value.

5. The method for adjusting the stereo image as claimed in claim 4, wherein the second depth value is zero parallax.

6. An image processing device, comprising:
a memory, storing a plurality of instructions; and
a processor, coupled to the memory, and executing the instructions to execute following steps:
obtaining a plurality of depth values of a stereo image, wherein a plurality of first depth values in the depth values correspond to a boundary region of a screen;
determining whether one of the first depth values is negative parallax; and
adjusting the depth values when one of the first depth values is negative parallax, such that the first depth values are not negative parallax.

7. The image processing device as claimed in claim 6, wherein the stereo image comprises a first image and a second image, and the steps of obtaining the depth values of the stereo image comprises:
obtaining a plurality of first feature points of the first image, and obtaining a plurality of second feature points of the second image; and
matching the first feature points and the second feature points to calculate the depth values.

8. The image processing device as claimed in claim 6, wherein the step of determining whether one of the first depth values is the negative parallax comprises:
obtaining a minimum depth value in the first depth values; and
determining whether the minimum depth value is negative parallax.

9. The image processing device as claimed in claim 8, wherein the step of adjusting the depth values such that the first depth values are not negative parallax comprises:
adding the minimum depth value by a shift value to generate a second depth value, wherein the second depth value is not negative parallax; and
adding the depth values other than the minimum depth value by the shift value.

10. The image processing device as claimed in claim 9, wherein the second depth value is zero parallax.
